(19) United States
(12) Patent Application Publication
(10) Pub. No.: US 2014/0056190 A1
(43) Pub. Date: Feb. 27, 2014

(54) Reducing Interference Caused by an Atmospheric Duct in a Wireless Communication System

(71) Applicants: Yu Qian, Beijing (CN); David Astely, Bromma (SE); Ali Behravan, Stockholm (SE); Jiansong Gan, Beijing (CN)

(72) Inventors: Yu Qian, Beijing (CN); David Astely, Bromma (SE); Ali Behravan, Stockholm (SE); Jiansong Gan, Beijing (CN)

(73) Assignee: TELEFONAKTIEBOLAGET L M ERICSSON (PUBL), Stockholm (SE)

(21) Appl. No.: 14/110,164

(22) PCT Filed: Apr. 8, 2011
(86) PCT No.: PCT/CN11/00607

§ 371 Date: Nov. 14, 2013

(51) Int. Cl. H04W 24/02

(52) U.S. Cl. CPC H04W 24/02
USPC 370/280

(57) ABSTRACT

A first base station (14) in a wireless communication system (10) operating according to a synchronised time division scheme detects interference of uplink communication, determines the delay of the interference in relation to an own communication structure (CS1), detects aerial interface identifying data of the source of interference identifying a further base station and sends an indication of the further base station interfering uplink communication to the interference handling node (22). The indication is accompanied by identification data comprising aerial interface identifying data of the further base station and distance data determining the distance (D1) between the first and the further base station. The interference handling node (37) receives the indication with accompanying identification data, investigates the identification data in order to determine the identity of a candidate for the further base station and orders the candidate base station to perform an interference limitation activity.

### TECHNICAL FIELD

The invention relates to interference between base stations in wireless communication systems. More particularly, the invention relates to a method and computer program product for handling interference in a wireless communication system operating according to a synchronised time division scheme, an interference handling node in such a wireless communication system, a method for reporting interference in such a wireless communication system as well as to a first base station in such a wireless communication system.

### BACKGROUND

There are today many mobile communication systems that use synchronised time division schemes, such as time division duplexing systems (TDD). One example of this is Time Division-Long Term Evolution (TD-LTE). These types of systems are provided with base stations, which have certain communication structures, such as frames or superframes provided after one another in time. The communication structures of the base stations are in these types of systems synchronised with each other. The base stations of many systems do more particularly often transmit signals in one period of the structure, often denoted downlink period, and receive signals in another period of the structure, often denoted uplink period. These periods should be sufficiently separated from each other in order to avoid that base station transmissions interfere with base station reception. Such a separation is in some systems denoted a guard period. If systems are synchronised this means that all base stations are transmitting at the same time and all are receiving at the same time.

There exist some prior art documents that adjust these communication structures.

WO 2008/103090 does for instance disclose measuring the interference level during part of the time between two consecutive down link periods and varying the duration of guard periods according to the interference level.

WO 2009/153622 describes determining, through an apparatus equipped with a transmitter that monitors signal energy on a shared radio resource, the presence of other transmitters, identification of a predetermined set of time division duplex (TDD) signaling patterns, performing of a correlation between signal energy received on the shared radio resource and the predetermined TDD signaling patterns and determining of a TDD signaling pattern that may reduce or avoid interference with other transmitters using the shared resource.

One problem that has received increased attention lately in relation to systems using synchronised time division schemes are problems caused by atmospheric ducts.

An atmospheric duct is a horizontal layer that is created in the lower atmosphere, typically the troposphere. In such a duct the vertical refractive index gradients are such that radio signals (and light rays) are guided or ducted along the length of the duct. The radio signals in the ducts therefore tend to follow the curvature of the Earth. They also experience less attenuation in the ducts than they would if the ducts were not present.

The occurrences and locations of these ducts are hard to predict. They occur rarely, typically a few days or a number of hours in one year, and also often occur in some special area, like in the desert or near the sea.

For a mobile communication system, an atmospheric duct will cause long-distance downlink (DL) signals for base stations to mobile stations to travel through the atmosphere with long transmission delay but with a very low attenuation.

This delayed but still strong signal may seriously affect TDD system performance.

Since the base stations in the above mentioned systems are supposed to transmit in well controlled periods of the communication structure and to receive signals from mobile stations in other periods of the communication structure, it is possible that the signals from a base station travelling through an atmospheric duct will reach another base station when this other base station is supposed to receive signals from mobile stations, i.e. when this other base station is in uplink communication.

This situation can be serious because base stations transmit with much more power than a mobile station. Since the signals in the atmospheric duct have low attenuations, this means that a base station may not be able to receive any signals from mobile stations in the whole or parts of the period of the communication structure assigned to reception of signals from mobile stations. This means that one of the fundamental base station functions may be impossible to perform.

It is also possible for a base station to interfere with uplink communication of another base station for other reasons, like if it has a faulty operation, like having lost its synchronisation.

There is therefore a need for a solution to this problem.

### SUMMARY

The invention is therefore directed towards solving the problem of limiting base station interference of uplink communication in a mobile communication system that uses a synchronised time division communication scheme.

One object of the invention is thus to solve, in an interference handling node of the wireless communication system, the problem of limiting base station interference of uplink communication in a mobile communication system that uses a synchronised time division communication scheme.

This object is according to a first aspect of the invention achieved through a method for handling interference in a wireless communication system operating according to a synchronised time division scheme. The method is performed in an interference handling node of the wireless communication system and comprises

receiving, from a first base station in a first group comprising at least one base station, an indication of a further base station interfering uplink communication of the first base station, where the indication is accompanied by identification data comprising aerial interface identifying data of the further base station and distance data determining the distance between the first and the further base station,

investigating the identification data in order to determine the identity of a candidate for the further base station, and

ordering the candidate base station to perform an interference limitation activity.

The object is according to a second aspect of the invention achieved through an interference handling node in a wireless communication system operating according to a synchronised time division scheme. The node comprises:

a communication interface for receiving, from a first base station in a first group comprising at least one base station, an indication of a further base station interfering uplink communication of the first base station, where the indication is accompanied by identification data comprising aerial interface identifying data of the further base station and distance data determining the distance between the first and the further base station, and

an interference handling module comprising an investigating unit that investigates the identification data in order to determine the identity of a candidate for the further base station, and

an interference limitation control unit that orders the candidate base station to perform an interference limitation activity.

The above-mentioned object is according to a third aspect of the invention achieved through a computer program product for handling interference in a wireless communication system operating according to a synchronised time division scheme. The computer program product comprises computer program code on a data carrier which when run on a processor forming an interference handling module of an interference handling node, causes the interference handling module to:

receive, from a first base station in a first group comprising at least one base station, an indication of a further base station interfering uplink communication of the first base station, where the indication is accompanied by identification data comprising aerial interface identifying data of the further base station and distance data determining the distance between the first and the further base station,

investigate the identification data in order to determine the identity of a candidate for the further base station, and

order the candidate base station to perform an interference limitation activity.

The invention has many advantages. It provides interference limitation in uplink communication, for instance caused by atmospheric ducts, which can cause serious problems. This may also be performed using only slight modifications of existing base stations. The invention is therefore also easy to implement in existing systems.

The system may be a time division duplexing system. It may also be a Universal Mobile Telecommunication System as well as a Long Term Evolution System.

The aerial interface identifying data may comprises or identify a cell identifier.

An interference limitation activity may to adjust antenna tilt, adjust traffic allocation, adjust downlink power and adjust an interval between uplink and downlink transmissions.

According to one variation of the invention the investigation of identification data in the method is performed according to a first scheme. This first scheme comprises investigating if another base station being identified by the aerial interface identifying data has sent an indication concerning a base station interfering uplink communication and identifying this other base station identified by the aerial interface identifying data as a candidate base station if it has.

According to the same variation of the invention the investigating unit of the interference handling node comprises a first operations element that performs investigations according to a first scheme. This scheme comprises investigating if another base station identified by the aerial interface identifying data has sent an indication concerning a base station interfering uplink communication and identifying this other base station identified by the aerial interface identifying data as a candidate base station if it has.

According to another variation of the invention the first group comprises more base stations. There also exists a second scheme, which comprises investigating if at least one other base station in the first group has sent an indication of the further base station interfering uplink communication and identifying a candidate further base station using distance data from the first base station and other base stations in the first group.

In the method the investigating of identification data is performed according to this variation made according to the second scheme.

According to the same variation the investigating unit in the interference handling node comprises a second operations element that performs investigations according to the second scheme.

According to a further variation of the invention, there is a third scheme comprising identifying a candidate base station as a base station placed a distance from the first base station defined by the distance data and being identified by having an aerial interface identifier corresponding to the aerial interface identifying data in the indication.

According to this variation the investigation of identification data in the method is performed according to this third scheme.

According to the same variation the identification data investigating unit of the interference handling node comprises a third operations element that performs investigations according to this third scheme. According to yet another variation of the invention, the method comprises selecting another candidate if the interference limitation activity is unsuccessful.

According to the same variation of the invention an operations module selects another candidate if the interference limitation activity is unsuccessful.

According to another variation of the invention, the method comprises continuing to another scheme if there is no further candidate in the investigated scheme.

According to the same variation of the invention the interference handling node comprises a scheme selection element configured to select between schemes and continue to another scheme if there is no further candidate in an investigated scheme.

Another object of the invention is thus to solve, in a base station of the wireless communication system, the problem of enabling limiting base station interference of uplink communication in a mobile communication system that uses a synchronised time division communication scheme.

This object is according to a fourth aspect of the invention achieved through a method for reporting interference in a wireless communication system operating according to a synchronised time division scheme. The method is performed in a first base station of the wireless communication system and comprises:

detecting interference of uplink communication, determining the delay of the interference in relation to the communication structure used by the first base station,

detecting aerial interface identifying data of the source of interference, which identifies a further base station, and

sending an indication of the further base station interfering uplink communication to an interference handling node. The indication is accompanied by identification data comprising aerial interface identifying data of the further base station and distance data determining the distance between the first and the further base station. This allows the interference handling node to control the performing of an interference limitation activity based on the identification data.

This object is according to a fifth aspect of the invention achieved through a first base station in a mobile communication system operating according to a synchronised time division scheme, where the first base station comprises:

at least one antenna,

a radio communication unit for communicating with mobile stations of the system via the antenna, and an interference investigating unit that detects interference of uplink communication,

a delay determining unit that determines the delay of the interference in relation to the communication structure used by the base station,

a communication structure investigating unit that detects aerial interface identifying data of the source of interference identifying a further base station, and an indication generating unit that generates and sends an indication of the further base station interfering uplink communication to an interference handling node.

The indication is accompanied by identification data comprising aerial interface identifying data of the further base station and distance data determining the distance between the first and the further base station. This allows the interference handling node to control the performing of an interference limitation activity based on the identification data.

The base station may be a NodeB base station and may also be an evolved NodeB base station.

According to one variation of the invention, the method according to the third aspect comprises continuously reporting the detected interference to the interference handling node until the interference limitation activity has been completed.

According to the same variation of the invention, the interference investigating unit of the first base station continuously reports the detected interference to the interference handling node until the interference limitation activity has been completed.

According to another variation of the invention, the detecting of aerial interface identifying data in the method according to the third aspect comprises muting transmissions in a part of a communication structure of the first base station assigned to downlink communication and listening to data sent by the further base station during the muted part of the communication structure.

According to the same variation of the invention, the indication generating unit of the first base station mutes the radio communication unit in a part of the communication structure assigned to downlink communication and the communication structure investigating unit is controlled to listen to data of the further base station sent during the muted part of the communication structure.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a wireless communication system comprising an O&M device and a number of base stations, where a first base station is communicating with a mobile station,

FIG. 2 shows a block schematic of the first base station according to one variation of the invention,

FIG. 3 shows a block schematic of an interference handling node according to one variation of the invention,

FIG. 4 schematically shows an atmospheric duct having been formed in the atmosphere above the earth,

FIG. 5 schematically shows the communication structures of two base stations in FIG. 1, the first base station and a further base station,

FIG. 6 schematically shows signals transmitted by a base station being used for identifying this base station,

FIG. 7 shows a flow chart of a general method for reporting interference in a mobile communication system according to a first embodiment of the invention being performed in the first base station,

FIG. 8 shows a flow chart of a general method of handling interference in an interference handling node according to the first embodiment of the invention,

FIG. 9 shows a number of method steps for reporting interference according in a wireless communication system according to a second embodiment of the method of detecting interference,

FIG. 10 shows a flow chart of a number of method steps for handling interference in a wireless communication system in a first part of a method for handling interference according to a second embodiment of the invention,

FIG. 11 shows a flow chart of a number of method steps for handling interference in a wireless communication system in a second part of the method for handling interference according to the second embodiment, and

FIG. 12 schematically shows a computer program product according to an embodiment of the invention in the form of a CD ROM disc.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

The present invention concerns a base station in a wireless communication system that may be a mobile communication system like Universal Mobile Telecommunication System (UMTS) and/or Long-Term Evolution (LTE). The system is furthermore a system that uses or operates according to a synchronised time division scheme, such as a time division duplexing system (TDD). In the example of LTE the system may be Time Division-Long Term Evolution (TD-LTE). It should be realized that the invention may be provide din other types of wireless communication systems using a synchronised time division scheme.

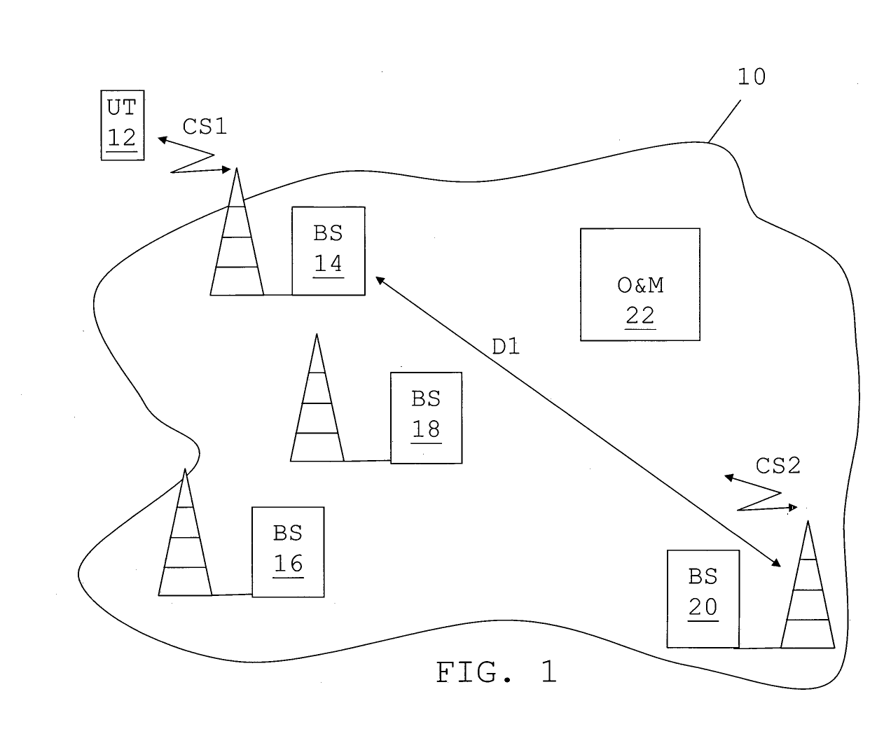

FIG. 1 schematically shows one exemplifying TD-LTE system 10. In this system there are a number of base stations 14, 16, 18 and 20. Base stations are in mobile communication systems often denoted node B's and in LTE evolved node B's (enodeB). There is here a first group of base stations comprising at least one base station. In this example it comprises three base stations: a first base station 14, a second base station 16 and a third base station 18. The base stations in this first group are neighbours, which in this case means that they provide cells that are placed adjacent each other. There is furthermore a further base station 20 in the system 10. This further base station 20 is provided on a long distance from the base stations in the first group and particularly on a long distance, here indicated as a distance D1, from the first base station 14. This further base station 20 may be a base station in a second group, where the base stations in the second group would also be neighbours to each other providing cells adjacent each other. Because of the long distance between the two groups, the further base station 20 would under normal atmospheric situations be provided on a long enough distance from the first group of base stations that the transmissions of the further base station 20 are attenuated enough for not influencing the operation of the first group of base stations.

In FIG. 1 there is furthermore indicated a first communication structure CS1 of the first base station 14 in which it is communicating with a mobile station 12 as well as a second communication structure CS2 used by the further base station 20. Also the second and third base stations 16 and 18 have similar communication structures. However, these have here been omitted in order to provide a clearer description of the invention. Furthermore, all the communication structures of the system 10 are synchronised with each other. In FIG. 1 there is furthermore shown an Operations and Maintenance (O&M) device 22, with which all of the base stations may communicate. This device is a part of an O&M subsystem in the mobile communication system. The operations and maintenance device 22 here also forms an interference handling node of the wireless communication system 10.

FIG. 2 shows a block schematic of the first base station 14. The first base station 14 comprises a radio communication unit 26 connected to at least one antenna for communicating with mobile stations of the system like the one shown in FIG. 1 via the at least one antenna. In this embodiment there is only one antenna 24. The first base station 14 furthermore comprises an interference investigating module 28 and a communication interface 36. The communication interface 36 may here be an S1 interface for communicating with other devices or nodes in the system, such as the O&M device. The interference investigating module 28 comprises a number of units. It includes an interference investigating unit IIU 30, an indication generating unit IGU 32, a delay determining unit DDU 31 and an aerial interface identifier detecting unit 34 AIDU. The interference investigating unit 30 is here connected to the radio communication unit 26 as well as to the indication generating unit 32, while the delay determining unit 31 is connected to the indication generating unit 32, to the radio communication unit 26 and to a communication structure investigating unit CSIU 35. The aerial interface identifier detecting unit 34, is also connected to the indication generating unit 32 and to the communication structure investigating unit 35, which in turn is connected to the antenna 24. In this embodiment of the invention the communication structure investigating unit 35 is provided as a separate entity from the interference investigating module 28. It is therefore provided in the form of a separate module, which may be in the form of a mobile station communication chipset.

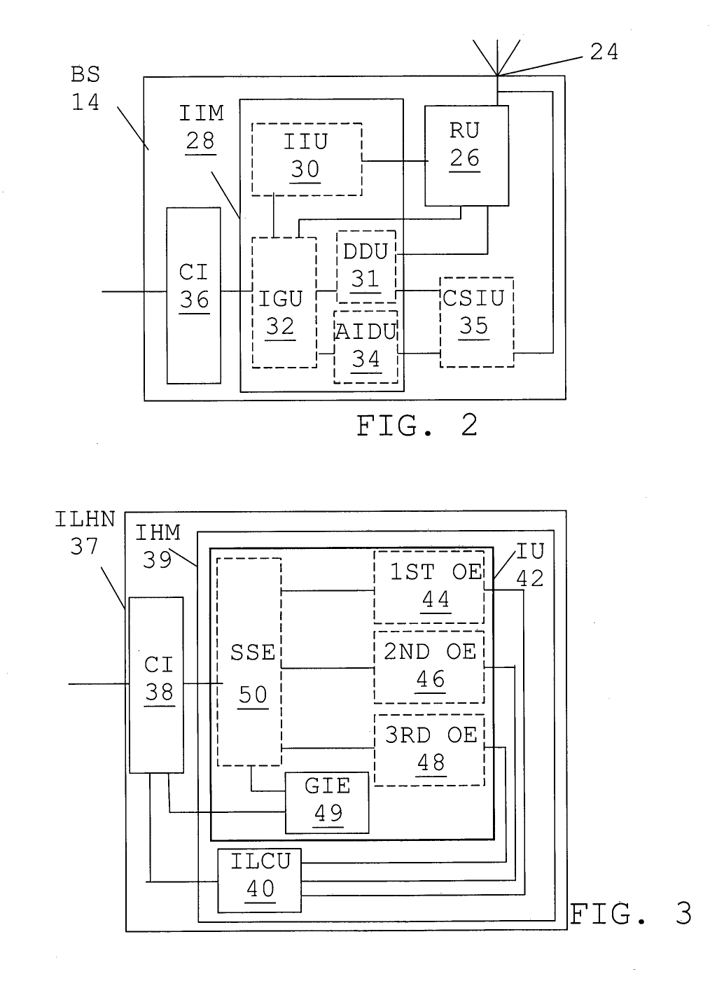

FIG. 3 shows a block schematic of an interference handling node 37, which, as was mentioned earlier, may be a part the O&M device in FIG. 1. This node 37 may thus include other units and entities involved in handling other functions. The node 37 comprises a communication interface 38, for instance an S1 interface, being connected to an interference handling module 39 that includes an investigating unit IU 42 and an interference limitation control unit ILCU 40. The communication interface 38 is more particularly connected to the interference limitation control unit 40 and to a scheme selection element 50 of the investigating unit 42. Here the investigating unit 42 furthermore comprises a first operations element 1^{st} OE 44 a second operations element 2^{nd} OE 46 and a third operations element 3^{rd} OE 48, where each of these operations elements is connected to the scheme selection element 50. They are also each connected to the interference limitation control unit 40. The investigating unit 42 also comprises a group identifying element 49 that is connected to the scheme selection element 50 as well as to the communication interface 38.

The operations elements here each handle an investigating scheme concerning interfering of base stations. In its simplest form, the invention is based on only one such scheme. If only one such scheme is used there would therefore only be one operations element and there need be no scheme selection element and possibly also no group identifying element.

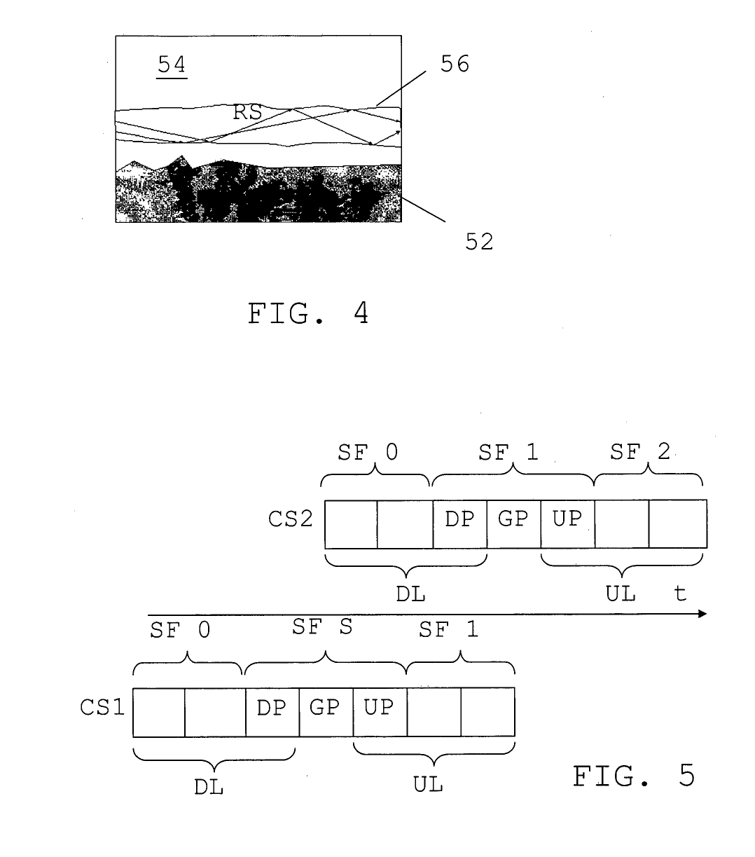

As was mentioned earlier there can at times occur atmospheric ducts in the atmosphere. Such a situation is schematically shown in FIG. 4, which shows an atmospheric duct 56 that has been created in the atmosphere 54 above ground 52. In FIG. 4 there is also shown how radio signals RS propagate in this duct along the length of the duct. Radio signals RS that are transported in this duct 56 can be propagated long distances with low attenuation. It can also be seen that the propagation of the radio signals is not straight. The consequence of this is that angle of arrival (AoA) combined with propagation time cannot be used for determining positions that are accurate.

FIG. 5 schematically shows the communication structures CS1 and CS2 of the first and the further base stations shown in FIG. 1. These communication structures CS1 and CS2 are both divided into a number of subframes, and in this example only three are displayed for showing the principle. These subframes follow each other in time. This means that there is here a subframe zero SF 0 followed by a special subframe SF S and a subframe one SF 1. All these subframes are divided into time slices. However, in the figure only three such time slices in the special subframe SF S are indicated by names. Subframe zero SF 0 is here only provided for downlink communication DL, i.e. communication from base station to mobile station, and subframe one SF 1 only for uplink communication UL, i.e. communication from mobile station to base station. The special subframe SF S includes three time slices, a downlink pilot time slice DP, a guard period GP and an uplink pilot time slice UP. In the downlink pilot time slice DP pilot signals are transmitted in the downlink DL, i.e. from base station to mobile stations, while in the uplink pilot time slice UP pilot signals are transmitted from the mobile stations to the base stations. In the guard period GP no transmissions are supposed to be made. This period is used for providing a sufficient separation between transmission and reception in the system. The guard period GP is thus an interval between uplink and downlink transmissions.

As was mentioned earlier all base station transmissions are synchronised. This means that the first and second communication structures CS1 and CS2 are in fact synchronised with each other. However, because of the delay of the signals in the further base station, the communication structure CS2 of the further base station is delayed in relation to the communication structure CS1 of the first base station. What is shown in FIG. 5 is thus the communication structures CS1 and CS2 as they are being provided and perceived by the first base station. It may here be further mentioned that there is also a delay between the first, second and third base stations. However, this delay is normally so small that it does not influence the operation of the system.

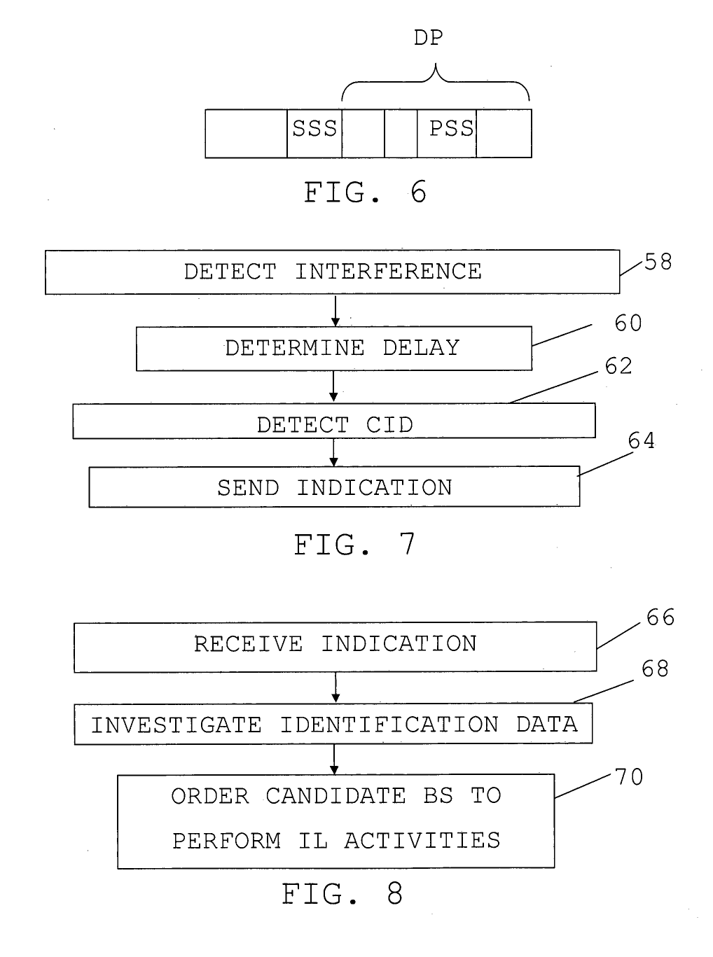

A base station transmits cell identifiers, where data specifying an aerial interface identifier, here a cell identifier, is transmitted in the downlink pilot time slice DP and in a transmission time interval (TTI) immediately preceding this time slice. FIG. 6 shows the transmission of a Secondary Synchronisation Signal (SSS) in the last slot or TTI of the Subframe zero SF 0, together with the transmission of the Downlink Pilot time slice DP including a primary Synchronization Signal (PSS). These signals SSS and PSS together specify an aerial interface identifier of a base station and here a cell identifier.

Atmospheric ducts, like the one shown in FIG. 4 may appear between the first group of base stations comprising the first, second and third base stations 14, 16 and 18 and the second group of base stations comprising the further base station 20. This means that the radio signals of the second group of base stations may be lead via this duct 56 to the first group of base stations. Also the signals of the first group of base stations may be led to the second group of base stations. As can be seen in FIG. 1, this thus means that the radio signals of the further base station 20 may be lead via the duct 56 to the first base station 14. In this case the communication structure CS2 of the further base station 20 may be delayed in relation to the communication structure CS1 of the first base station 14 in the way shown in FIG. 5. As can be seen from FIG. 5 the downlink transmissions DL of the further base station 20 may then coincide with the uplink transmissions UL to the first base station 14. This means that the first base station 14 will receive radio signals from the further base station 20 when it is supposed to receive radio signals from the mobile stations in its vicinity, like the mobile station 12. A base station transmits with a lot more power than a mobile station. This therefore means that due to the low attenuation of the transmissions of the further base station 20, these transmissions will make it more or less impossible for the first base station 14 to be able to receive any radio signals from the mobile stations in the uplink, like mobile station 12. The interference from the further base station 20 will be too high. It can here furthermore be mentioned that it is also possible to be interfered during uplink communication by another base station if this other base station is faulty, like if it has lost its synchronisation. The invention is provided for addressing both these situations.

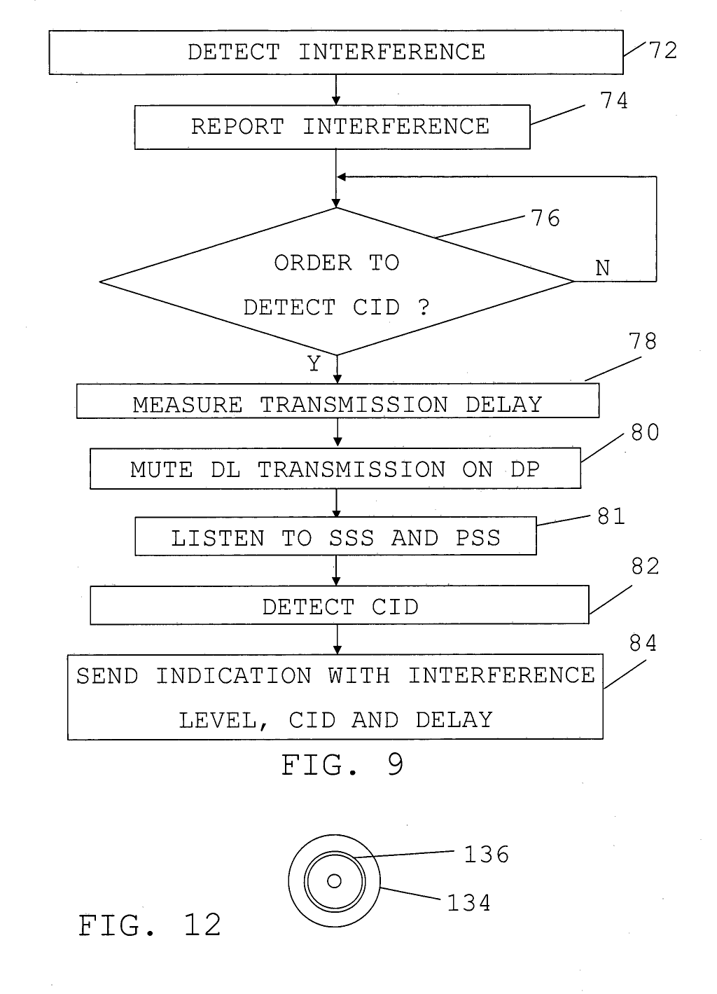

A first embodiment of the invention will now be described with reference being made to the previous figures as well as to FIG. 7, which shows a flow chart of a general method for reporting interference in a wireless communication system according to a first embodiment of the invention and to FIG. 8, which shows a flow chart of a general method for handling interference in a wireless communication system according to the first embodiment of the invention.

According to the first embodiment the interference investigating unit 30 of the first base station 14 detects interference of uplink communication, step 58, which may be done via link quality measurements that are measured in the base station 14 during uplink communication UL between mobile stations in contact with the first base station. This determining is typically done through the interference investigating unit 30 connecting to the radio communication unit 26 during uplink transmissions and obtaining interference measurements from the radio communication unit 26. These are typically measurements relating to one or more uplink channels in the communication structure CS1. When the interference investigating element 30 has obtained the link quality measurements, it determines if an uplink channel is interfered by another base station or not based on if a link quality threshold is crossed or not. In case the threshold is not crossed, i.e. a normal link quality is obtained, then the method may be ended. However, in case the threshold is crossed, the interference investigating element 30 may determine that there is in fact interference.

This detecting of interference may then be notified to the indication generating unit 32, which goes on and orders the delay determining unit 31 to determine the delay of the interference. The delay determining unit 31 thereafter determines the delay of the interference in relation to the transmissions of the first base station 14, step 60. This is typically done through determining the delay of the second communication structure CS2 in relation to the first communication structure CS1. In order to do this the delay determining unit may gather information of the first communication structure form the radio communication unit 26 and information about the second communication structure from the communication structure investigating unit 35, which may monitor the transmissions of the further base station. Also the aerial interface identifier detecting unit 34 may here be instructed to detect aerial interface identifying data of the source of interference, i.e. identifying the interfering further base station 20. The unit 34 then orders the communication structure investigating unit 35 to monitor the downlink pilot transmission time slice DP and some transmissions time intervals before this in the communication structure of the interfering base station in order to be able to detect PSS and SSS, which transmissions are thus made in the second communication structure CS2. The content of these signals is then reported to the aerial interface identifier determining unit 34, which detects an aerial interface identifier in the form of a cell identifier CID through analysing these signals PSS and SSS, step 62, which cell identifier CID is reported to the indication generating unit 32.

The indication generating unit 32 in turn goes on and generates an indication of the interference. This is an indication of the further base station interfering uplink communication of the first base station, i.e. interfering the communication from mobile stations to the first base station. Here this indication is accompanied by identification data comprising aerial interface identifying data and distance data determining the distance D1 to the further base station 20. In this embodiment the aerial interface identifying data is the aerial interface identifier in the form of the cell identifier of the further base station 20. Thereafter the indication generating unit 32 sends the indication together with the cell identifier CID and distance data to the interference limitation handling node 37 via the communication interface 36, step 64, where the indication with accompanying data is sent in order to allow the interference handling node to control the performing of an interference limitation activity based on the identification data.

Such reporting of detected interference may thereafter be continuously reported to the interference handling node until the interference limitation activity has been completed.

The distance data may here be the actual distance which the distance determining unit 31 has determined based on the determined delay. The distance data may also be the delay itself, which delay may be used by the interference handling node 37 to determine the distance D1 from the first base station 14 to the further base station 20.

The indication with accompanying data is then received in the communication interface 38 of the interference handling node 37, step 66, from where it is forwarded to the investigating unit 42 of the interference handling module 39. The investigating unit 42 then investigates the identification data in order to determine the identity of a candidate for the further base station, step 68.

The investigation is here made of the distance and cell identifier. A candidate can here be identified according to any of a number of schemes, of which three will be described later. Once a candidate has been identified, the investigating unit 42 orders the candidate base station to perform an appropriate interference limitation activity, step 70. If the candidate was the further base station the interference will be limited and the method ended. In case the candidate was not the further base station another candidate base station is chosen according to the same or another scheme until the further base station has been correctly identified and the interference caused by it limited.

The invention according to a second preferred embodiment of the invention will soon be described, but before this is done some further details regarding the environment in which the invention is provided will be given.

First of all when there is interference because of an atmospheric duct, the interference is normally reciprocal. This means that a first base station being interfered by a further base station will most probably also interfere the further base station. Furthermore if there is a first group of neighbouring base stations experiencing interference, there is then also normally a second group of base stations that are the sources of this interference as well as being interfered by the base stations in the first group.

The cell identifiers detected through the signals PSS and SSS are not unique. They are reused in the system. This means that once a cell identifier is obtained, this identifier can be used by several base stations in the wireless communication system. The cell identifier is thus shared with more base stations in the system. This means that this type of cell identifier cannot be used to uniquely identify an interfering base station. Furthermore, the angle of arrival is not suitable to use, since the propagation in a duct is not straight.

The SSS signal does for instance identify a cell identity within a cell-identity group, while the PSS signal identifies a cell identity group. These together provide a fairly good, however not unique, identification of the further base station.

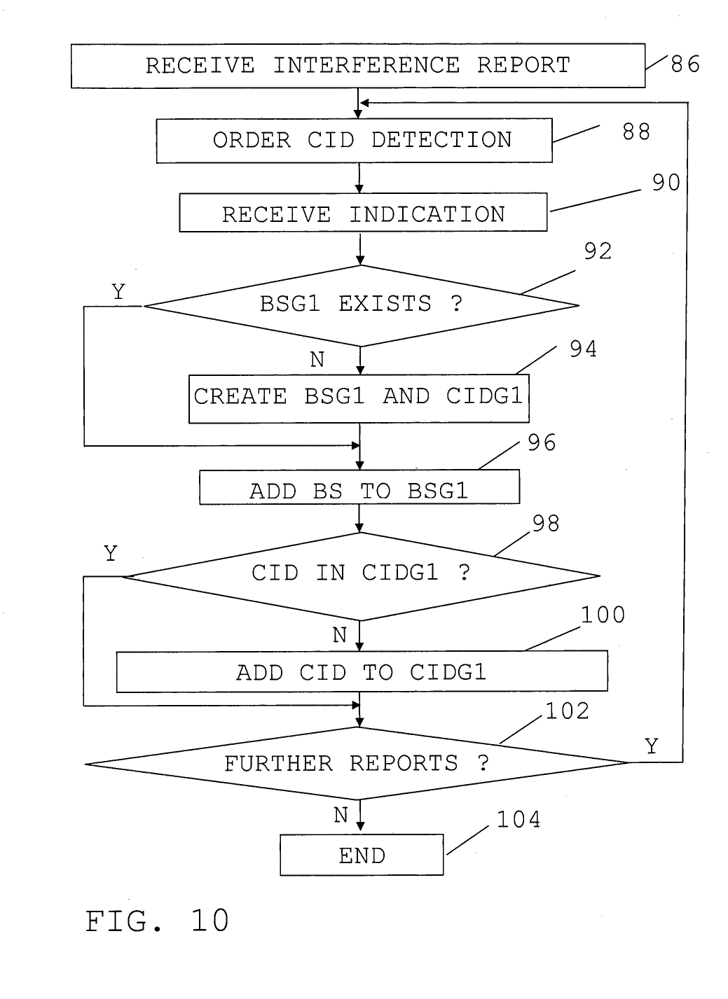

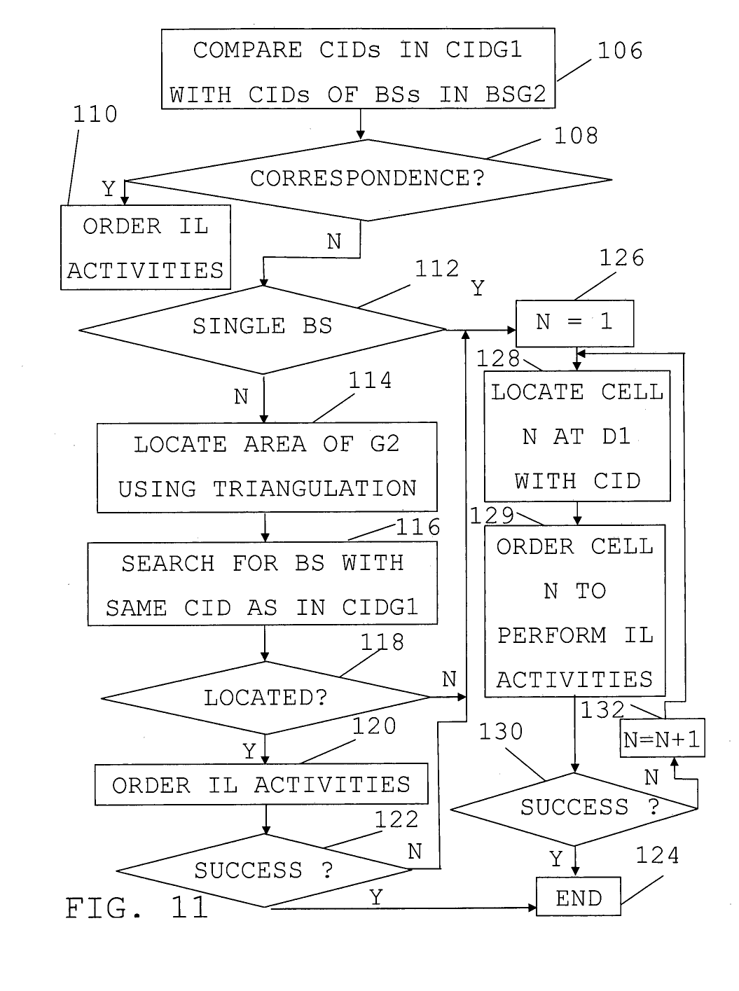

The second embodiment of the invention will now be described with reference being made to the previous FIGS. 1-6 as well as to FIG. 9, which shows a flow chart of a method for reporting interference in a wireless communication system according to the second embodiment of the invention, to FIG. 10, which shows a flow chart of a first part of a method for handling interference in a wireless communication system according to the second embodiment of the invention and to FIG. 11, which shows a flow chart of a second part of the method for handling interference in a wireless communication system according to the second embodiment.

According to the second embodiment the interference investigating unit 30 of the first base station 14 detects interference of uplink communication, step 72, which may be done in the same way as in the first embodiment. However, in this second embodiment, the interference investigating unit 30 reports the fact that there is interference of the uplink communication to the interference handling node 37 via the communication interface 36, step 74. This report may also include a level of interference experienced by the first base station.

The interference report is then received by the investigating unit 42 of the interference handling module 39, step 86. This is here more particularly received by the scheme selecting element 50. This element may notice that the level of interference is too high to be caused by mobile stations. It may then order the base station that sent the report to detect a cell identifier, step 88. This order may also include an order to detect the distance to an interfering base station, step 88.

The indication generating unit 32 of the first base station, after having sent the report of the interference, waits for the order to detect cell identity CID and if the order is not received, step 76, it keeps on waiting for the order. Once the order is received, step 76, the indication generating unit 32 orders the delay determining unit 32 to determine the delay, which is done by this unit 31 in the same way as in the first embodiment while employing the communication structure investigating unit 35. The delay determining unit 31 thus measures the transmission delay of the interference, step 78, and reports this delay to the indication generating unit 32. Also the aerial interface identifier detecting unit 34 is here ordered by the indication generating unit 32 to detect a cell identifier.

In order to do this the indication generation unit 32 first mutes the down link transmission on the downlink pilot time slice DP of the first communication structure CS1, step 80. The muting may here be performed in an O&M controlled muting time instance or with an asynchronised muting pattern, which is done in order to avoid total silence. It thus order the radio communication unit 26 to mute transmissions in a part of the communication structure assigned to downlink communication. This enables the communication structure investigating unit 35 to be able to listen to transmissions being made by the further base station 20 in the downlink DL of the communication structure CS1 of the first base station 14. The aerial interface identifier detecting unit 34 more particularly orders the communication structure investigating unit 35 to listen to data in the form of the SSS and PSS signals, being sent or transmitted by the further base station during the muted part of the communication structure, step 81, and based on these the aerial or cell identifier of the further base station 20 is detected by the aerial interface identifier detecting unit 34, step 82. In this embodiment the aerial interface identifier detecting unit 34 makes the determination and reports the cell identifier CID to the indication generating unit 32.

The indication generating unit 32 then goes on and generates an indication of the interference. Here this indication may also include an interference level and is furthermore accompanied by the cell identifier CID of the further base station and distance data determining the distance D1 to the further base station 20. Thereafter the indication generating unit sends the indication together with the accompanying data, step 84.

The indication is then received by the interference handling module 39 of the interference handling node 37 via the communication interface 38. It is more particularly received in the group identifying element 49, step 90. The first thing that this element does is to investigate if there exists a first base station group, i.e. if there exists a group of base stations in the neighbourhood of the first base station 14 that have reported similar interferences, i.e. have reported interferences from base stations at about the same distance and having the same or other reported cell identifiers. In case no such first group BSG1 exists, step 92, the group identifying element 49 goes on and creates such a first group BSG1 as well as a corresponding cell identifier group CIDG1, step 94, and then proceeds to a following step of adding the first base station BS1 to the first base station group BSB1, step 96.

In case the first base station group existed, step 92, the first base station 14 is directly added to the first base station group, step 96. As an example the first group may be formed by the first, second and third base stations 14, 16 and 18, in which case the second and third base stations may previously have reported interference from the further base station 20 or from the second group including the further base station 20. In case the first base station group existed it is clear that also the first cell identifier group will exist. Therefore, after adding the first base station 14 to the first base station group BSG1, the group identifying element 49 continues and investigates if the cell identifier CID reported by the first base station 14 is in the first cell identifier group CIDG1. If it is not, step 98, the group identifying element 49 adds the cell identifier CID to the group, step 100, and goes on and investigates if there are any other interference reports received from other neighbouring base stations or from the first base station concerning other interfering base stations. In case the cell identifier already existed in the first group, step 98, the scheme selecting element directly continues and investigates if there are further interference reports. If there are, step 102, then the base stations performing the reporting are asked to detect cell identifiers of interfering base stations. If these base stations are new neighbouring base stations, they will be added to the first base station group BSG1 and if the detected cell identifiers are new cell identifiers these will be added to the first cell identifier group CIDG1 in the above described manner. If there are no further reports, step 102, then this first part of the method is ended, step 104.

The activities described above were activities performed in relation to the first base station 14 and other base stations in the first group of base stations BSG1. It should here be realized that the same activities may be performed in relation to the further base station. This means that the further base station and neighbours of this further base station may in the same way report interference and be asked to detect cell identifiers of the sources of interference. In this way the interference handling node 37 may create a second group of base stations BSG2 with a corresponding second group of cell identifiers CIDG2 of the base stations that are interfering the base stations in the second group.

After this has been done the group identifying element 49 informs the scheme selecting element 50 about the existing base station groups and cell identity groups. The scheme selecting element 50, which is configured to select among various schemes, then sets out to investigate the identity of the further base station 20. In case there is a first and a second base station group BSG1 and BSG2, then the scheme selection element 50 orders the first operations element 44 to investigate the reported cell identifier CID, i.e. the cell identifier reported by the first base station 14. The first operations element 44 here compares the cell identifiers in the first group of cell identifiers CIDG1 with cell identifiers of base stations in the second base station group BSG2, step 106. In case there is a coincidence or correspondence, step 108, the base stations in the second group for which there is a correspondence are then set as candidate base stations. This means that if another base station than the first base station has sent an indication concerning a base station interfering uplink communication, which other base station is identified by the aerial interface identifying data, here the cell identifier reported by the first base station, then this other base station is identified as a candidate base station.

The first operations element 44 thereafter informs the interference limitation control unit 40 of the identity of these candidate base stations in the second group. The interference limitation control unit 40 then orders these candidate base stations in the second group corresponding to the cell identifiers of the first cell identity group CIDG1 to perform interference limitation activities, step 110. This may involve ordering the interfering base stations to perform the activities simultaneously. It may also involve ordering them to perform the activities sequentially. More particularly this involves ordering a candidate base station in the second group being associated with the cell identifier of the further base station to perform interference limitation activities.

Here one of the candidates is more or less certainly in fact the further base station itself. The order to perform interference limitation may here be sent to the candidate base station using a communication identifier associated with a transport network of the wireless communication system, which identifier may with advantage be an Internet Protocol (IP) address associated with the further base station.

In the case of interference caused by an atmospheric duct, the likelihood that the base stations in the first base station group BSG1 are interfering the base stations in the second base station group BSG2 is also high and therefore the scheme selecting element 50 would normally also order the first operations element 44 to perform the same type of investigation regarding the correspondence of cell identifiers in the second group of cell identifiers CIDG2 and the base stations in the first group of base stations BSG1 and the first operations element 44 would then also, after a successful investigation, instruct the interference limitation control unit 40 to order these base stations in the first base station group BSG1 to perform interference limitation activities. This may then be based on the base stations continuing to report interference and repeated iteratively.

In case there is no correspondence between cell identifiers in the first group of cell identifiers CIDG1 and the second group of base stations BSG2, step 108, for instance if there is no second group, then the first operations element 44 informs the scheme selecting element 50 of this fact. The scheme selecting element 50 then investigates if the first base station group BSG1 only includes a single base station or not through querying the group identifying element 49, and if the first base station group BSG1 includes more than one base station, step 112, then the scheme selecting element 50 instructs the second operations element 46 to locate the identity of the interfering base station using a second scheme. This means that an investigating is made if at least one other base station than the first base station in the first group has sent an indication of the further base station interfering uplink communication and the second scheme is selected if this is the case.

In this second scheme the second operations element 46 locates the area of the interfering base station using triangulation, step 114. This means that it uses the distance information obtained from the base stations in the first group to obtain one or two areas where the interfering base station should be located. Thereafter the second operations element 46 searches in this area or in these areas for a candidate base station having the same cell identity as the cell identity reported in the first cell identity group CIDG1, step 116. This means that in this second scheme a candidate base station is identified using distance data from the first base station and from other base stations in the first group. If the second operations element 46 locates the candidate base station, step 118, the second operations element 46 informs the interference limitation control unit 40 of the candidate base station. The interference limitation control unit 40 then instructs the located candidate base station to perform interference limitation activities, step 120. If these are successful, step 122, and the candidate base station thus is the further base station 20, the method is ended, step 124. That the candidate base station is the further base station may be determined through the ceasing of sending indications by the first base station.

However, if they are not successful, step 122, which may be understood from the continued reception of interference reports from the first base station 14, another candidate base station is selected. If there are remaining candidates in the second scheme, the scheme selecting element may select one of these. However if there are no more candidates in this scheme it may continue to another scheme. In this example the scheme selecting element 50 continues through instructing the third operations element 48 to locate the further base station.

The third operations element 48 starts with setting a counter n equal to one, step 126. Thereafter it locates a first cell n with a cell identify CID at a distance of D1, i.e. at the reported distance from the first base station 14 that has the reported cell identity CID, step 128. The identity of this candidate base station is then reported to the interference limitation control unit 40, which goes on and orders the candidate base station to perform interference limitation activities, step 129, and if these are successful then the method is ended, step 124, where the determination of success can be made in the same way as in the second scheme. If however, the activities were not successful, step 130, another candidate is selected. This is in this example done through incrementing the counter n so that n=n+1, step 132. Thereafter a cell n is again located, step 128, and ordered to perform interference limitation activities, step 129. This then continues until the correct base station, the further base station 20, is identified.

It can here be seen that a candidate base station is identified as a base station placed a distance from the first base station defined by the distance data and being identified by having an aerial interface identifier corresponding to the aerial interface identifying data in the indication.

It can thus be seen that in the third scheme base stations on a circle around the first base station 14 with a radius that is set as the distance D1 are investigated concerning correspondence of cell identifier. The base stations on this circle that have the cell identifier are then asked to perform interference limitation activities until the correct base station has been identified. It is furthermore possible that there is some uncertainty regarding the correctness of the distance between the first and the further base station. This may be handled through investigating an area between two circles, where one of the circles is provided inside the other. The radius of the inner circle is then set to a minimum value and the outer radius to a maximum value of the distance between the first and further base station. Here the minimum value could for instance be 90% of the mean distance between the first and the further base station and the maximum value could be 110% of the mean distance between the first and the further base station.

The interference limitation activity may comprise changing of the guard period GP in the special subframe SF S, i.e. to change an interval between uplink and downlink transmissions. However, also other types of interference limitation activities are possible, such as adjusting antenna tilt, lowering down of downlink power or adjusting of traffic allocation.

In this way it is possible to limit uplink interference, for instance caused by atmospheric ducts, which can cause serious problems. This may also be performed using only slight modifications of existing base stations and O&M nodes. It is therefore also easy to implement in existing systems.

It should here also be mentioned that it is possible also to instruct the neighbouring base stations in the first group to perform interference limitation measures.

The interference investigating module of the first base station may with advantage be provided in the form of a processor with associated program memory including computer program code for performing the functionality of the various units in it. It should be realized that this module may also be provided in the form of hardware, like for instance in the form of an Application Specific Integrated Circuit (ASIC). The computer program code may also be provided on a computer-readable means, for instance in the form of a data carrier, like a CD ROM disc or a memory stick, which will implement the function of the above-described interference investigating module when being loaded into the above-mentioned program memory and run by the processor. Also the interference handling module of the interference handling node may be provided in the form of a processor with associated program memory including computer program code for performing the functionality of the various units and elements of this module. It should also here be realized that this module may also be provided in the form of hardware, like for instance in the form of an Application Specific Integrated Circuit (ASIC). The computer program code may also be provided on a computer-readable means, for instance in the form of a data carrier, like a CD ROM disc or a memory stick, which will implement the function of the above-described interference handling module when being loaded into the above-mentioned program memory and run by the processor. One such computer program product in the form of a CD ROM disc 134 with such a computer program code 136 for providing the function of the interference investigating module and/or interference handling module is schematically shown in FIG. 12.

A base station does normally not include the functionality of the communication structure investigating unit, because it is not able to detect downlink signals. This functionality may be added through providing the communication structure investigating unit in the form of a mobile station communication unit, for instance a mobile station radio chipset. This unit may then be configured to communicate with the interference handling module with a private interface. In the described embodiments this unit is connected to the antennas of the base station for instance only using one or two ports. As an alternative it may use separate mini antennas near the base station antennas or radio communication unit, where these antennas would only be receiving antennas in order not to add to the interference. When remote interference is detected, the base station DL transmission is turned off in the last DL TTI and the DL receiver of the communication structure investigating unit turned on, but not the UL transmitter of this unit, for the interfered base station in the last DL TTI and the following downlink pilot time slice, guard period, and uplink pilot time slice, which could be driven by the interference handling node or base station.

In the described embodiment the aerial interface identifier detecting unit was part of the interference investigating module in a base station. It is as an alternative possible that this unit is provided in the interference handling node. In this case it is possible that the communication structure investigating unit communicates with this node in order to let the node in question determine aerial interface identifier. This means that aerial interface identifying data sent from the base station may be at least some of the content of the SSS and PSS signals, from which the node can identify a cell identifier.

There are a number of further variations that can be made in the system and first base station. The further base station was above described as being part of the same system as the further base station. This may not necessarily be the case. The further base station may be part of another system, however of the same type as the one in which the first base station is provided. The O&M device may then not directly know the identity of the base station based on the cell identifier, but may need to query other O&M devices in other systems. An IP address is also just one example of a system communication identifier that can be used.

The interference handling node was previously described as being provided in an O&M device. However it is possible to place it in another node of the wireless communication system, such as a Mobility Management Entity (MME) node.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims. Furthermore, the invention is not limited to the specific order in which steps are presented in the method claims.

1-20. (canceled)

21. A method for handling interference in a wireless communication system operating according to a synchronized time division scheme, the method being performed in an interference handling node of the wireless communication system and comprising the steps of:
receiving, from a first base station in a first group comprising at least one base station, an indication of a further base station interfering with uplink communication of the first base station, said indication being accompanied by identification data, said identification data comprising aerial interface identifying data of the further base station and distance data determining the distance between the first and the further base station,
investigating the identification data in order to determine the identity of a candidate for the further base station, and
ordering the candidate base station to perform an interference limitation activity.

22. The method according to claim 21, wherein the step of investigating identification data is performed according to a first scheme comprising investigating whether another base station being identified by the aerial interface identifying data has sent an indication concerning a base station interfering uplink communication and, if it has, identifying this other base station as the candidate base station.

23. The method according to claim 21, wherein the first group comprises more base stations and the step of investigating identification data is performed according to a second scheme comprising investigating whether at least one other base station in the first group has sent an indication of the further base station interfering with uplink communication and identifying a candidate base station using distance data from the first base station and from other base stations in the first group.

24. The method according to claim 23, further comprising continuing to another scheme if there are no further candidate base stations in the investigated scheme.

25. The method according to claim 23, further comprising selecting another candidate base station as the further base station, if the interference limitation activity is unsuccessful.

26. The method according to claim 21, wherein the step of investigating identification data is performed according to a third scheme comprising identifying a candidate base station as a base station placed a distance from the first base station defined by the distance data and being identified by having an aerial interface identifier corresponding to the aerial interface identifying data in the indication.

27. The method according to claim 21, wherein the aerial interface identifying data comprises or identifies a cell identifier.

28. An interference handling node in a wireless communication system operating according to a synchronized time division scheme and comprising:
a communication interface for receiving, from a first base station in a first group comprising at least one base station, an indication of a further base station interfering with uplink communication of the first base station, said indication being accompanied by identification data, said identification data comprising aerial interface identifying data of the further base station and distance data determining the distance between the first and the further base station, and
an interference handling module comprising an investigating unit configured to investigate said identification data in order to determine the identity of a candidate base station as said further base station, and
an interference limitation control unit configured to order the candidate base station to perform an interference limitation activity.

29. The interference handling node according to claim 28, wherein the investigating unit comprises a first operations element configured to perform investigations according to a first scheme comprising investigating whether another base station being identified by said aerial interface identifying data has sent an indication concerning a base station interfering uplink communication and, if it has, identifying this other base station identified by the aerial interface identifying data as the candidate base station.

30. The interference handling node according to claim 28, wherein the first group comprises more base stations and the investigating unit comprises a second operations element configured to perform investigations according to a second scheme comprising investigating whether at least one other base station in the first group has sent an indication of the further base station interfering with the uplink communication and identifying a candidate base station using distance data from the first base station and other base stations in the first group.

31. The interference handling node according to claim 30, wherein an operations module is further configured to select another candidate if the interference limitation activity is unsuccessful.

32. The interference handling node according to claim 30, wherein the identification data investigating unit comprises a scheme selection element configured to select between schemes and continue to another scheme if there is no further candidate base station in an investigated scheme.

33. The interference handling node according to claim 28, wherein the identification data investigating unit comprises a third operations element configured to perform investigations according to a third scheme comprising identifying a candidate base station as a base station placed a distance from the first base station defined by the distance data and having an aerial interface identifier corresponding to the aerial interface identifying data in the indication.

34. A computer program product for handling interference in a wireless communication system operating according to a synchronized time division scheme, the computer program product comprising computer program code on stored on a computer readable medium and, when run on a processor forming an interference handling module of an interference handling node, causes the interference handling module to:
receive, from a first base station in a first group comprising at least one base station, an indication of a further base station interfering with uplink communication of the first base station, said indication being accompanied by identification data, said identification data comprising aerial interface identifying data of the further base station and distance data determining the distance between the first and the further base station,
investigate said identification data in order to determine the identity of a candidate for the further base station, and
order the candidate base station to perform an interference limitation activity.

35. A method for reporting interference in a wireless communication system operating according to a synchronized time division scheme, the method being performed in a first base station of the wireless communication system and comprising the steps of:
detecting interference of uplink communication,
determining the delay of the interference in relation to the communication structure used by the first base station,
detecting aerial interface identifying data of the source of interference, which identifies a further base station, and
sending an indication of the further base station with interfering uplink communication to an interference handling node, said indication being accompanied by identification data, said identification data comprising aerial interface identifying data of the further base station and distance data determining the distance between the first and the further base station in order to allow the interference handling node to control the performing of an interference limitation activity based on the identification data.

36. The method according to claim 35, wherein the detected interference is continuously reported to the interference handling node until the interference limitation activity has been completed.

37. The method according to claim 35, wherein the detecting of aerial interface identifying data comprises muting transmissions in a part of the communication structure of the first base station assigned to downlink communication and listening to Primary and Secondary Synchronization signals sent by the further base station during the muted part of the communication structure.

38. A first base station in a mobile communication system operating according to a synchronized time division scheme and comprising:
at least one antenna,
a radio communication unit for communicating with mobile stations of the system via the antenna, and
an interference investigating unit configured to detect interference of uplink communication,
a delay determining unit configured to determine the delay of the interference in relation to the communication structure used by the base station,
a communication structure investigating unit configured to detect aerial interface identifying data of the source of interference, which identifies a further base station, and
an indication generating unit configured to generate and send an indication of the further base station interfering uplink communication to an interference handling node, said indication being accompanied by identification data, said identification data comprising aerial interface identifying data of the further base station and distance data determining the distance between the first and the further base station in order to allow the interference handling node to control the performing of an interference limitation activity based on the identification data.

39. The first base station according to claim 38, wherein the interference investigating unit is configured to continuously report the detected interference to the interference handling node until the interference limitation activity has been completed.

40. The first base station according to claim 38, wherein the indication generating unit is configured to mute the radio communication unit in a part of the communication structure assigned to downlink communication and the communication structure investigating unit is configured to be controlled to listen to Primary and Secondary Synchronization signals of the further base station sent during the muted part of the communication structure.
